(19) United States
(12) Patent Application Publication
(10) Pub. No.: US 2012/0027393 A1
(43) Pub. Date: Feb. 2, 2012

(54) ELECTRONIC EQUIPMENT

(75) Inventors: Yoshiyuki TSUDA, Hirakata City (JP); Masahiro Yokohata, Osaka (JP); Haruo Hatanaka, Kyoto (JP)

(73) Assignee: SANYO Electric Co., Ltd., Mariguchi City (JP)

(21) Appl. No.: 13/189,365

(22) Filed: Jul. 22, 2011

(30) Foreign Application Priority Data
Jul. 27, 2010 (JP) 2010-168699

(51) Int. Cl. G03B 13/00

(52) U.S. Cl. 396/102

(57) ABSTRACT

An electronic equipment includes a digital focus portion that adjusts an in-focus state of a target image by image processing, and a unit adjustment amount setting portion that sets a unit adjustment amount in adjustment of the in-focus state based on distance information of the target image.

### CROSS-REFERENCE TO RELATED APPLICATIONS

This nonprovisional application claims priority under 35 U.S.C. §119(a) on Patent Application No. 2010-168699 filed in Japan on Jul. 27, 2010, the entire contents of which are hereby incorporated by reference.

### BACKGROUND OF THE INVENTION

1. Field of the Invention

The present invention relates to electronic equipment such as a digital camera.

2. Description of Related Art

There is proposed a function of adjusting an in-focus state of a target image by image processing, and a type of processing for realizing this function is also called a digital focus. The in-focus state of the target image means, for example, a depth of field of the target image or an in-focus distance of the target image (e.g., a center of the depth of field).

As a method of determining the in-focus state, there are considered a complete automatic setting method, a method of designating a subject by a user, and a complete manual setting method.

In the complete automatic setting method, the digital camera automatically performs detection of a main subject and setting of an in-focus distance and a depth of field adapted to the main subject.

In the method of designating a subject by a user, the user selects and designates a subject to be focused using a touch panel or the like, and the digital camera sets the in-focus distance and the depth of field in accordance with the designation.

In the complete manual setting method, a user manually inputs all the in-focus distance and the depth of field.

However, in the complete automatic setting method, as illustrated in FIG. 18A, an actual in-focus distance and an actual depth of field may be largely different from the in-focus distance and the depth of field desired by the user.

In addition, in the method of designating a subject by a user, a result image that substantially meets the user's intention can be obtained, but fine adjustment of the in-focus state is difficult. For instance, in a result image obtained as illustrated in FIG. 18B, not only a designated subject 911 but also a subject 912 positioned in the vicinity of the designated subject 911 is focused by the digital focus. However, the user may want a shallow depth of field in which only the designated subject 911 is focused. In this case, a fine adjustment of the in-focus distance and/or the depth of field is necessary. However, according to the method of determining the in-focus distance and the depth of field according to only the designated content of the subject, such fine adjustment is difficult.

On the other hand, in the complete manual setting method, the in-focus distance and the depth of field can be designated as the user wants. In this case, the digital camera cannot recognize a user's intention unless the user performs an input operation. Therefore, as illustrated in FIG. 18C, for example, a distance range from a position 921 near the digital camera to a position 922 corresponding to the point at infinity is divided into steps at a constant interval, and an instruction to adjust the in-focus distance and the depth of field per step is accepted. For instance, if a desired in-focus distance is positioned on the long distant side of the current designated in-focus distance by 30 steps, it is necessary to perform a unit operation of moving the designated in-focus distance to the long distant side 30 times. A load of such an operation is large, and a simpler operation method is expected to be proposed. In this case, it is needless to say that it is desirable to realize a method satisfying a user's intention.

### SUMMARY OF THE INVENTION

Electronic equipment according to an aspect of the present invention includes a digital focus portion that adjusts an in-focus state of a target image by image processing, and a unit adjustment amount setting portion that sets a unit adjustment amount in adjustment of the in-focus state based on distance information of the target image.

Electronic equipment according to another aspect of the present invention includes a digital focus portion that adjusts an in-focus state of a target image including a depth of field of the target image by image processing, and a unit adjustment amount setting portion that sets a unit adjustment amount in adjustment of the depth of field based on an in-focus distance as a reference distance in the depth of field.

### BRIEF DESCRIPTION OF THE DRAWINGS

FIG. 1 is a schematic general block diagram of an imaging apparatus according to a first embodiment of the present invention.

FIG. 2 is an internal structural diagram of an imaging portion illustrated in FIG. 1.

FIG. 3 is a block diagram of a part that is particularly related to digital focus according to the first embodiment of the present invention.

FIG. 4 is a diagram illustrating a positional relationship between the imaging apparatus and a plurality of subjects supposed in the first embodiment of the present invention.

FIGS. 5A and 5B are diagrams illustrating examples of a target input image and a target output image, respectively, according to the first embodiment of the present invention.

FIG. 6 is a diagram illustrating a distance distribution of a subject distance according to the first embodiment of the present invention.

FIG. 7 is a diagram illustrating a classification of a subject presence distance range and a subject absence distance range based on a distance distribution of the subject distance according to the first embodiment of the present invention.

FIG. 8 is a diagram illustrating a plurality of step positions set based on the distance distribution of the subject distance according to the first embodiment of the present invention.

FIG. 9 is a diagram illustrating a width between neighboring step positions according to the first embodiment of the present invention.

FIG. 10 is a diagram illustrating an outline of a setting method of a unit adjustment amount according to the first embodiment of the present invention.

FIG. 11 is a modified block diagram of the part that is particularly related to the digital focus according to the first embodiment of the present invention.

FIG. 12 is a flowchart of an operation of generating the target output image from the target input image according to the first embodiment of the present invention.

FIG. 13 is a diagram illustrating four buttons that can be disposed in the operating portion according to the first embodiment of the present invention.

FIG. 14 is a diagram illustrating an example of a display screen during the adjustment of the in-focus state according to the first embodiment of the present invention.

FIG. 15 is a diagram illustrating an example of a display screen during the adjustment of the in-focus state according to the first embodiment of the present invention.

FIG. 16 is a diagram illustrating a classification of a fine adjustment range and a rough adjustment range based on an in-focus distance according to the second embodiment of the present invention.

FIG. 17 is a diagram illustrating a width between neighboring step positions according to the second embodiment of the present invention.

FIGS. 18A to 18C are diagrams illustrating conventional methods for adjusting the in-focus state.

### DETAILED DESCRIPTION OF THE PREFERRED EMBODIMENTS

Hereinafter, examples of embodiments of the present invention are described in detail with reference to the attached drawings. In the diagrams that are referred to, the same portion is denoted by the same numeral or symbol, and overlapping description of the same portion is omitted as a rule.

### First Embodiment

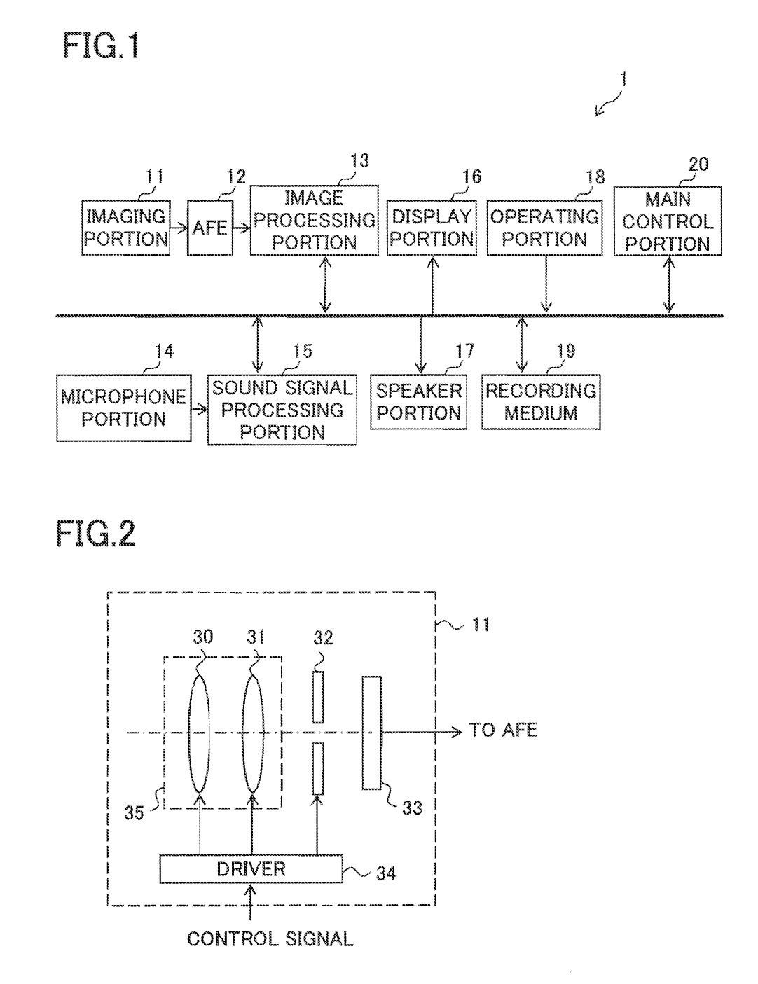

A first embodiment of the present invention is described. FIG. 1 is a schematic general block diagram of an imaging apparatus 1 according to the first embodiment. The imaging apparatus 1 is a digital still camera that can take and record still images, or a digital video camera that can take and record still images and moving images. The imaging apparatus 1 may be one incorporated in a mobile terminal such as a mobile phone.

The imaging apparatus 1 includes an imaging portion 11, an AFE 12, an image processing portion 13, a microphone portion 14, a sound signal processing portion 15, a display portion 16, a speaker portion 17, an operating portion 18, a recording medium 19, and a main control portion 20.

FIG. 2 illustrates an internal structural diagram of the imaging portion 11. The imaging portion 11 includes an optical system 35, an aperture stop 32, an image sensor 33 constituted of a charge coupled device (CCD) or a complementary metal oxide semiconductor (CMOS) image sensor, and a driver 34 that drives and controls the optical system 35 and the aperture stop 32. The optical system 35 is constituted of a plurality of lenses including a zoom lens 30 and a focus lens 31. The zoom lens 30 and the focus lens 31 can move in the optical axis direction. The driver 34 drives and controls positions of the zoom lens 30 and the focus lens 31, and an aperture of the aperture stop 32 based on control signals from the main control portion 20, so as to control a focal length (an angle of view) of the imaging portion 11, a focal position of the same, and an incident light amount to the image sensor 33 (i.e., an aperture stop value).

The image sensor 33 performs photoelectric conversion of an optical image expressing a subject, which has entered through the optical system 35 and the aperture stop 32 and output an electric signal obtained by the photoelectric conversion to the AFE 12. The AFE 12 amplifies an analog signal output from the imaging portion 11 (image sensor 33) and converts the amplified analog signal into a digital signal. The AFE 12 outputs the digital signal as RAW data to the image processing portion 13. An amplification degree of the signal amplification in the AFE 12 is controlled by the main control portion 20.

The image processing portion 13 generates image data expressing an image taken by the imaging portion 11 (hereinafter referred to also as a taken image) based on the RAW data from the AFE 12. The image data generated here contains, for example, a luminance signal and a color difference signal. However, the RAW data is also one type of the image data, and the analog signal output from the imaging portion 11 is also one type of the image data.

The microphone portion 14 converts ambient sound around the imaging apparatus 1 into a sound signal and output the result. The sound signal processing portion 15 performs necessary sound signal processing on the output sound signal of the microphone portion 14.

The display portion 16 is a display device having a display screen such as a liquid crystal display panel, and displays a taken image or an image recorded in the recording medium 19 under control of the main control portion 20. The display and the display screen in the following description mean the display and the display screen of the display portion 16 unless otherwise noted. The speaker portion 17 is constituted of one or more speakers, which reproduce and output sounds of various sound signals such as a sound signal generated by the sound signal processing portion 15 and a sound signal read out from the recording medium 19. The operating portion 18 is a part that receives various operations from a user. An operation content of the operating portion 18 is transmitted to the main control portion 20 and the like. The recording medium 19 is a nonvolatile memory such as a card-like semiconductor memory or a magnetic disk, which records the taken image and the like under control of the main control portion 20. The main control portion 20 integrally controls operations of the individual parts in the imaging apparatus 1 in accordance with operation content of the operating portion 18.

Operation modes of the imaging apparatus 1 includes an imaging mode in which a still image or a moving image can be taken, and a reproduction mode in which a still image or a moving image recorded in the recording medium 19 can be reproduced on the display portion 16. In the imaging mode, images of the subject are periodically taken at a predetermined frame period, and the imaging portion 11 (more specifically, the AFE 12) outputs the RAW data expressing a series of taken images of the subject. A series of images such as a series of taken images means a set of images arranged in time series. The image data of one frame period expresses one image. One taken image expressed by the image data of one frame period from the AFE 12 is referred to also as a frame image. It can be interpreted that the frame image is an image obtained by performing a predetermined image processing (a demosaicing process, a noise reduction process, a color correction process, or the like) on the taken image of the RAW data.

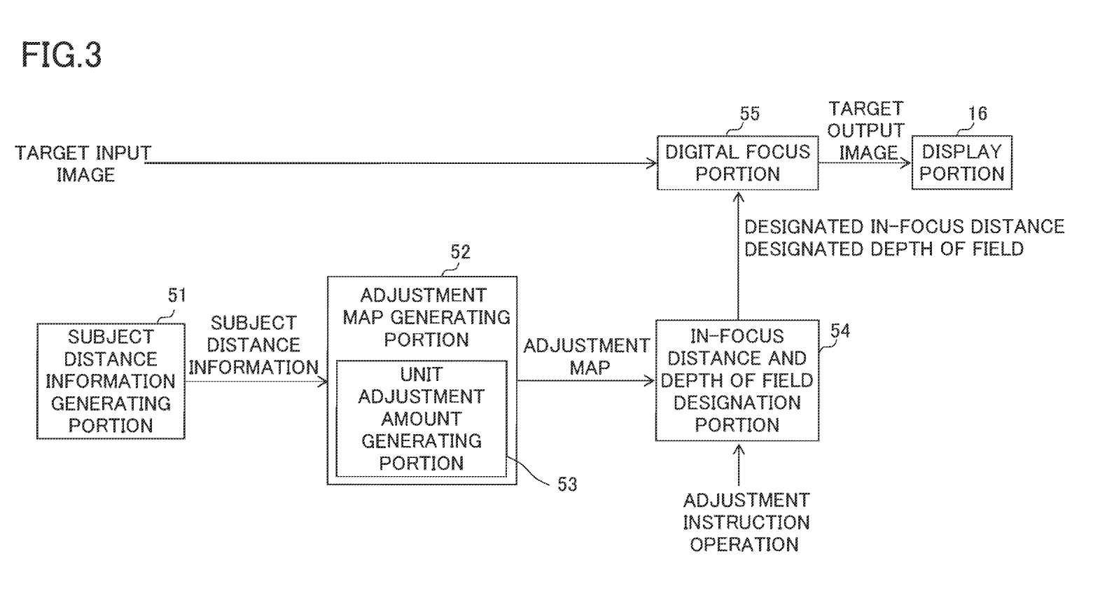

The imaging apparatus 1 has a function of adjusting the in-focus state of the target input image by image processing after obtaining the image data of the target input image. The process of realizing this function is referred to as a digital focus. The digital focus can be performed in the reproduction mode. The target input image is a frame image obtained as a still image or a frame image constituting a moving image. FIG. 3 illustrates a block diagram of a part that is particularly related to the digital focus. Individual parts denoted by numerals 51 to 55 can be disposed in the imaging apparatus 1. For instance, an adjustment map generating portion 52 including a unit adjustment amount generating portion 53 and an in-focus distance and depth of field designation portion 54 can be disposed in the main control portion 20 illustrated in FIG. 1, and an digital focus portion 55 can be disposed in the image processing portion 13 illustrated in FIG. 1.

The target input image after the adjustment of the in-focus state by the digital focus is referred to as a target output image. The in-focus state to be adjusted by the digital focus includes the in-focus distance of the target input image and a depth value of the depth of field of the target input image.

The in-focus distance of the target image as the target input image or the target output image is a reference distance in the depth of field of the target image, and is typically a distance at a center in the depth of field of the target image, for example. As known well, subjects having subject distances within the depth of field are focused in the target image. When the in-focus state of the target input image is adjusted by the digital focus, if the user performs the unit operation one time, the in-focus state of the target input image is changed by the unit adjustment amount. For instance, if the user performs the unit operation one time, the in-focus distance is increased or decreased by the unit adjustment amount, or the depth of field is increased or decreased by the unit adjustment amount. In other words, the unit adjustment amount indicates an adjustment amount of the in-focus distance or the depth of field by the unit operation (per unit operation). The unit adjustment amount and the adjustment amount can be read as a unit change amount and a change amount, respectively. In the first embodiment, the unit adjustment amount is set by using subject distance information. Hereinafter, operations of individual parts illustrated in FIG. 3 are described in detail.

The subject distance information generating portion 51 detects subject distances of subjects within an imaging range of the imaging portion 11, so as to generate subject distance information indicating subject distances of subjects at positions on the target input image. The subject distance of the subject means a distance in real space between the subject and the imaging apparatus 1 (more specifically the image sensor 33). The image sensor 33 that takes the target input image corresponds to an view point of the target input image. Therefore, the subject distance information of the target input image is information indicating a distance between the subject of each position on the target input image and the view point of the target input image (i.e., information indicating a distance between the subject at each position on the target input image and the imaging apparatus 1 as an apparatus used for taking the target input image). Note that in this specification, the expression that the distance is large and the expression that the distance is long have the same meaning, while the expression that the distance is small and the expression that the distance is short have the same meaning. The subject distance information is a distance image (in other words, range image) of which each pixel value has a measured value (i.e., a detected value) of the subject distance. As a method of detecting the subject distance and a method of generating the subject distance information, any known method (e.g., a method described in JP-A-2009-272799) can be used.

It is possible to generate the subject distance information from image data of the target input image or to generate subject distance information from information other than the image data of the target input image. For instance, it is possible to generate the subject distance information using a distance measuring sensor (not shown) for measuring subject distance of the subject at each position on the target input image. As the distance measuring sensor, any known distance measuring sensor such as a distance measuring sensor based on triangulation can be used. Alternatively, for example, a compound eye camera may be used for generating the distance image. Alternatively, for example, a contrast detection method may be used. In this case, for example, a position of the focus lens 31 is moved step by step by a predetermined amount while image data are obtained sequentially from the AFE 12. The distance image can be generated from high frequency components of spatial frequency components of the obtained image data.

Alternatively, for example, the imaging portion 11 may be formed so that the RAW data contains information indicating the subject distance, and the subject distance information may be generated from the RAW data. In order to realize this, for example, a method called “Light Field Photography” (e.g., a method described in WO/06/039486 Pamphlet or JP-A-2009-224982, hereinafter, referred to as a light field method) may be used. In the light field method, an imaging lens having an aperture stop and a micro lens array are used so that the image signal obtained from the image sensor also contains light propagation direction information in addition to light intensity distribution on a light receiving surface of the image sensor. Therefore, although not illustrated in FIG. 2, optical members necessary for realizing the light field method are disposed in the imaging portion 11 if the light field method is used. The optical members include a micro lens array and the like, and hence incident light from the subject enters the light receiving surface (i.e., an imaging surface) of the image sensor 33 via the micro lens array and the like. The micro lens array is constituted of a plurality of micro lenses, and one micro lens is assigned to one or more light receiving pixels of the image sensor 33. Thus, an output signal of the image sensor 33 also contains information of incident light propagation direction to the image sensor 33 in addition to the light intensity distribution on the light receiving surface of the image sensor 33.

A generation timing of the subject distance information is arbitrary. For instance, it is possible to generate the subject distance information when the target input image is taken or just after taking the same. In this case, the image data of the target input image and the subject distance information are associated with each other and are recorded in the recording medium 19. Then, before performing the digital focus, the image data of the target input image together with the subject distance information are read out from the recording medium 19. Alternatively, for example, it is possible to generate the subject distance information just before the digital focus is performed. In this case, after the target input image is taken, the image data of the target input image and information to be a base of the subject distance information are associated with each other and are recorded in the recording medium 19. When the digital focus is performed, the image data of the target input image and the information to be a base of the subject distance information are read out from the recording medium 19. Then, the subject distance information is generated from the read information. Note that as understood from the above-mentioned description, the information to be a base of the subject distance information can be the same as the image data of the target input image or can include the image data of the target input image.

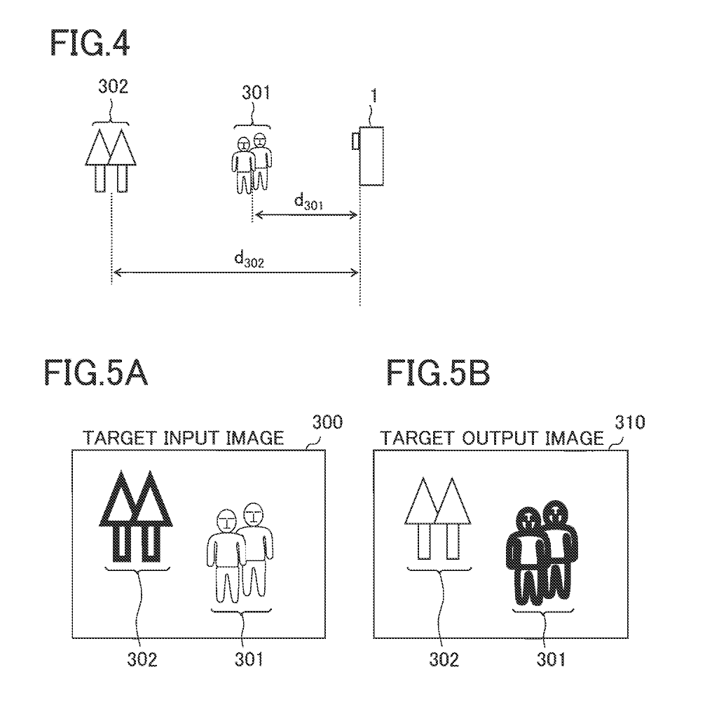

As illustrated in FIG. 4, it is supposed that the target input image is taken in the state where a subject 301 that is a person and a subject 302 that is a tree are included in the imaging range of the imaging portion 11. The subject 301 is supposed to be one or more persons, and in the example of FIG. 4, two persons form the subject 301. The subject 302 is one or more trees, and the subject 302 is constituted of two trees in the example illustrated in FIG. 4. The subject distances of the subject 301 are distributed around a distance d₃₀₁ as the center, and the subject distances of the subject 302 are distributed around a distance d₃₀₂ as the center. It is supposed that the subject 301 is a subject on the short distance side, and that the subject 302 is a subject on the long distance side. Therefore, “0<d₃₀₁<d₃₀₂” is satisfied.

An image 300 illustrated in FIG. 5A is an example of a target input image taken in the state where the subjects 301 and 302 are included in the imaging range of the imaging portion 11. In the target input image 300 illustrated in FIG. 5A, a whole or a part of the subject 301 is in focus, while the subject 302 is not in focus. In FIG. 5A, contour lines of objects in the target input image 300 are thickened so as to express blur of the image (the same is true in FIG. 5B and the like that will later be referred to). For instance, if the in-focus distance of the target input image 300 is changed to a subject distance d₃₀₂ by the digital focus, a target output image 310 as illustrated in FIG. 5B is obtained. In the following description, for specific description, a case in which the target input image 300 of FIG. 5A is obtained as the target input image is supposed as an example. Note that, for convenience sake of description, it is supposed that any subject other than the subjects 301 and 302 did not exist in the imaging range of the imaging portion 11 when the target input image 300 was taken.

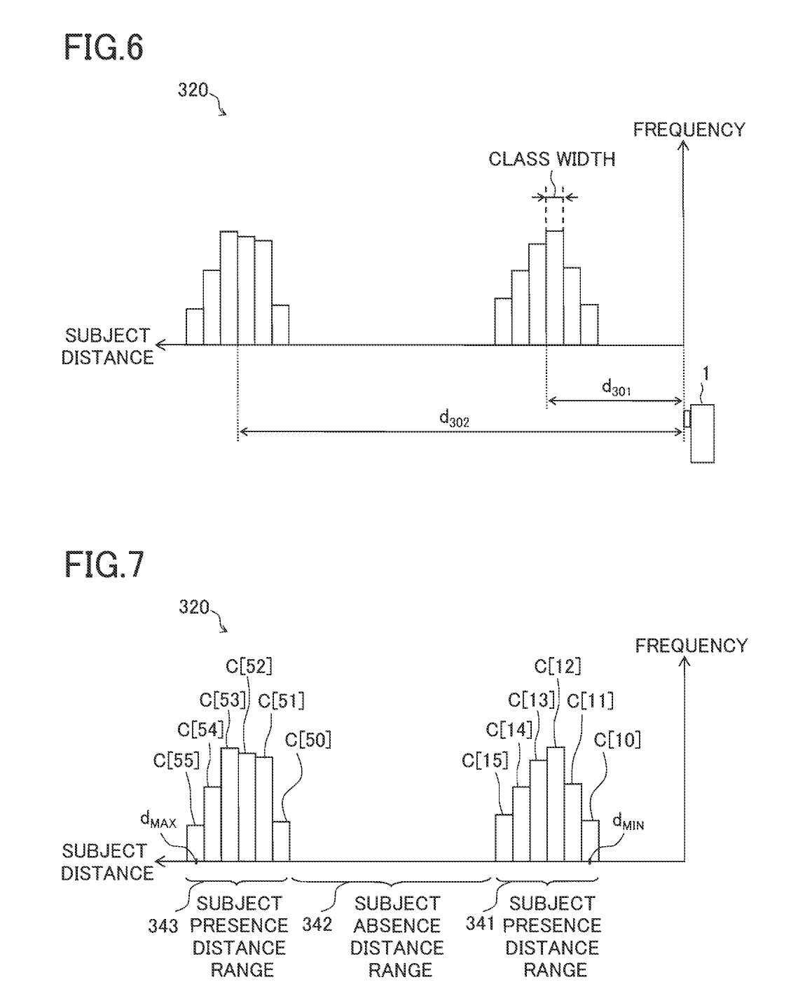

FIG. 6 illustrates a distance distribution 320 based on subject distance information of the target input image 300. As described above, the subject distance information is a distance image of which each pixel value has a measured value of the subject distance. A histogram as a graph of a distribution of pixel values in the distance image is the distance distribution 320.

When the distance distribution 320 is formed, each pixel value (i.e., subject distance) in the distance image is classified in one of classes, and each class width of the distance distribution 320 can be a predetermined distance width (e.g., a few centimeters to a few ten centimeters). The i-th class forming the distance distribution 320 is expressed by C[i] (see FIG. 7 too). The symbol i denotes an integer. It is supposed that a distance belonging to a class C[i+1] is larger than a distance belonging to a class C[i], and any two different classes do not overlap each other. For instance, subject distances larger than or equal to 1.0 meter and smaller than 1.2 meters belong to the class C[i], subject distances larger than or equal to 1.2 meters and smaller than 1.4 meters belong to the class C[i+1], and subject distances larger than or equal to 1.4 meters and smaller than 1.6 meters belong to a class C[i+2]. The class width may be different between different classes. As illustrated in FIG. 6, in the distance distribution 320, most of frequencies are concentrated on a portion around the distance d₃₀₁ and a portion around the distance d₃₀₂.

It is supposed that frequencies of a predetermined threshold value F_{TH} or larger belong only to each of the classes C[10] to C[15] and C[50] to C[55] among all the classes of the distance distribution 320 (F_{TH} denotes a natural number). A class to which frequencies of the threshold value F_{TH} or larger belong is referred to as a subject presence class, while a class to which frequencies of the threshold value F_{TH} or larger do not belong is referred to as a subject absence class. Therefore, in the distance distribution 320, the classes C[10] to C[15] and C[50] to C[55] are subject presence classes, while other classes are subject absence classes.

In addition, as illustrated in FIG. 7, a set of distances belonging to the subject presence class is referred to as a subject presence distance range, while a set of distances belonging to the subject absence class is referred to as a subject absence distance range. Therefore, in the distance distribution 320, a set of distances belonging to the classes C[10] to C[15] forms a subject presence distance range 341 (hereinafter may be briefly referred to as a presence range 341), while a set of distances belonging to the classes C[50] to C[55] forms a subject presence distance range 343 (hereinafter may be briefly referred to as a presence range 343). A set of distances disposed between the presence ranges 341 and 343 belonging to classes C[16] to C[49] forms a subject absence distance range 342 (hereinafter may be briefly referred to as an absence range 342). The subject presence distance range can be said to be a subject distance range in which a subject presence degree of the target input image is relatively large, while the subject absence distance range can be said to be a subject distance range in which a subject presence degree of the target input image is relatively small.

In addition, a minimum distance and a maximum distance among subject distances of the target input image 300 are denoted by d_{MIN} and d_{MAX}, respectively.

The subject distance information of the target input image 300 is given to the adjustment map generating portion 52 of FIG. 3. The adjustment map generating portion 52 extracts the minimum and the maximum subject distances from the subject distance information of the target input image, and generates the distance distribution based on the subject distance information of the target input image, and detects the above-mentioned subject presence distance range and the subject absence distance range from the distance distribution. When the target input image is the image 300, the minimum distance d_{MIN} and the maximum distance d_{MAX} are extracted from the subject distance information of the target input image 300, and the distance distribution 320 is generated based on the subject distance information of the target input image 300, and then the presence ranges 341 and 343 and the absence range 342 are detected from the distance distribution 320.

Based on the distance distribution, the adjustment map generating portion 52 sets the unit adjustment amount and generates an adjustment map on which content of the setting is reflected. The setting of the unit adjustment amount can be performed by the unit adjustment amount generating portion 53 that is a part of the adjustment map generating portion 52.

The setting method of the unit adjustment amount and the generating method of the adjustment map based on the distance distribution will be described. Meanings of the unit adjustment amount and the adjustment map will be apparent from the following description.

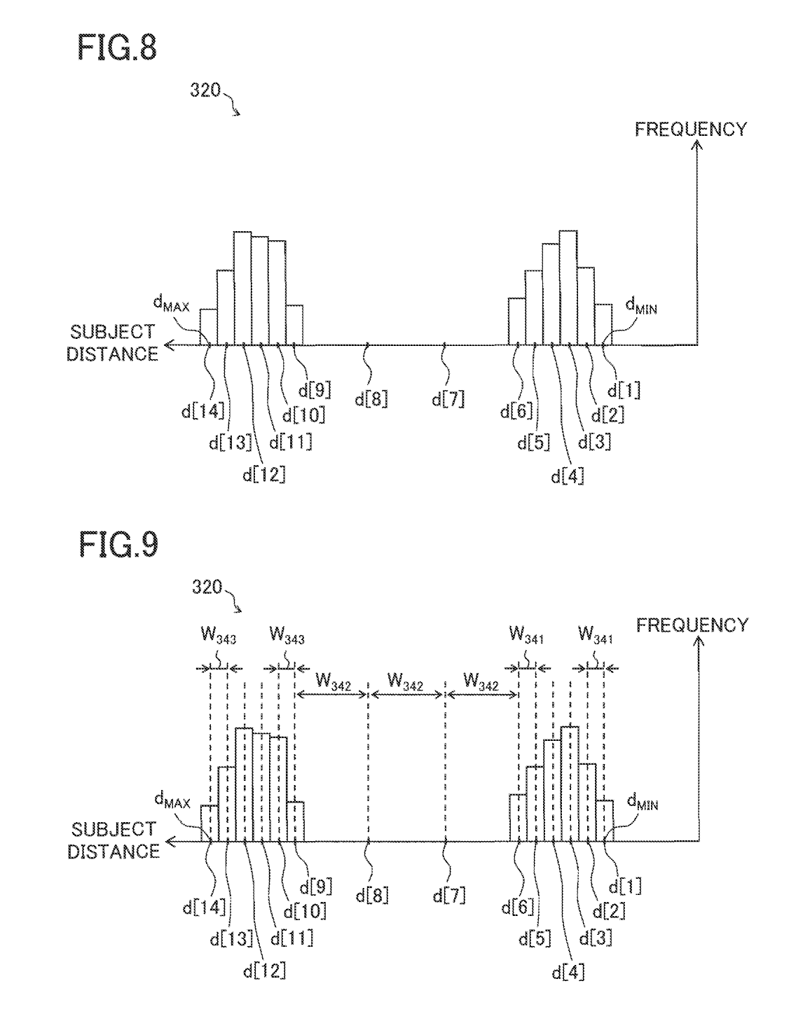

The adjustment map generating portion 52 splits the distance range from the minimum distance d_{MIN} to the maximum distance d_{MAX} into a plurality of unit distance ranges. In this case, by the adjustment map generating portion 52, a width of the unit distance range for the subject presence distance range is set to be smaller than a width of the unit distance range for the subject absence distance range. For instance, in the example of the distance distribution 320, step positions d[1] to d[14] as illustrated in FIG. 8 are set.

The subject distance at a step position d[i+1] for an arbitrary integer i is larger than the subject distance at a step position d[i], and subject distances at step positions d[1] and d[14] are equal to the minimum distance d_{MIN} and the maximum distance d_{MAX}, respectively. The subject distance at the step position d[i] means a subject distance of a subject that is supposed to be positioned at the step position d[i]. In addition, step positions d[1] to d[6] belong to the presence range 341, step positions d[7] and d[8] belong to the absence range 342, and step positions d[9] to d[14] belong to the presence range 343. A range from the step position d[i] to the step position d[i+1] for an arbitrary integer i is the unit distance range. Therefore, in the example of FIG. 8, the distance range from the minimum distance d_{MIN} to the maximum distance d_{MAX} is split into thirteen unit distance ranges. A unit distance range from the step position d[i] to the step position d[i+1] is expressed as a unit distance range (d[i], d[i+1]). Of course, the number of the unit distance ranges is not limited to 13.

The adjustment map generating portion 52 sets a width of each unit distance range belonging to the presence range 341 and a width of each unit distance range belonging to the presence range 343 to be smaller than a width of each unit distance range belonging to the absence range 342. As for a given unit distance range, if at least a part of the unit distance range belongs to the absence range 342, the unit distance range is considered to belong to the absence range 342. Therefore, the unit distance range (d[6], d[7]) can be said to belong to both the presence range 341 and the absence range 342, but the unit distance range (d[6], d[7]) is regarded to belong to the absence range 342. Similarly, the unit distance range (d[8], d[9]) is also regarded to belong to the absence range 342.

Then, the unit distance ranges belonging to the presence range 341 are unit distance ranges (d[1], d[2]), (d[2], d[3]), (d[3], d[4]), (d[4], d[5]) and (d[5], d[6]). The unit distance ranges belonging to the absence range 342 are unit distance ranges (d[6], d[7]), (d[7], d[8]) and (d[8], d[9]). The unit distance ranges belonging to the presence range 343 are unit distance ranges (d[9], d[10]), (d[10], d[11]), (d[11], d[12]), (d[12], d[13]) and (d[13], d[14]).

As illustrated in FIG. 9, the width of each unit distance range belonging to the presence range 341 can be set to a constant width W₃₄₁, the width of each unit distance range belonging to the absence range 342 can be set to a constant width W₃₄₂, and the width of each unit distance range belonging to the presence range 343 can be set to a constant width W₃₄₃. Here, “0<W₃₄₁<W₃₄₂” and “0<W₃₄₃<W₃₄₂” are satisfied. The width W₃₄₁ and the width W₃₄₃ may be the same or may be different from each other. Note that the width of the unit distance range may be different among a plurality of unit distance ranges belonging to the presence range 341, the width of the unit distance range may be different among a plurality of unit distance ranges belonging to the absence range 342, and the width of the unit distance range may be different among a plurality of unit distance ranges belonging to the presence range 343. However, in this case too, as described above, a width of each unit distance range belonging to the presence ranges 341 and 343 is set to be smaller than a width of each unit distance range belonging to the absence range 342.

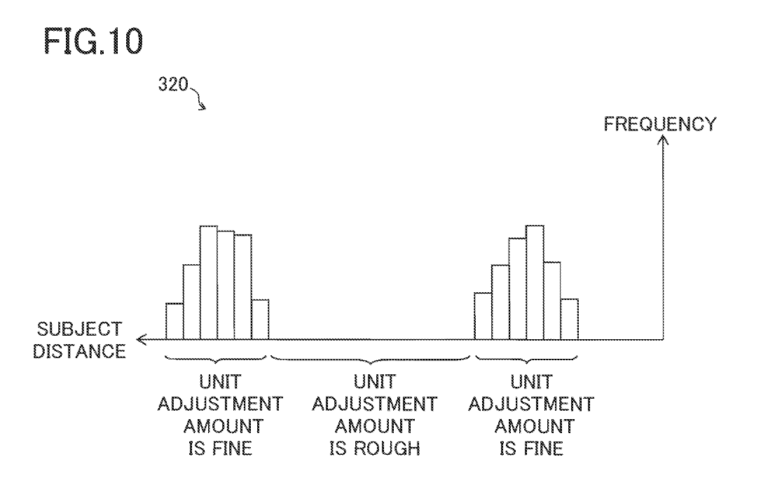

The width of each unit distance range can work as the unit adjustment amount. Then, a process of setting the step positions d[1] to d[14] satisfying the above-mentioned relationship corresponds to the setting process of the unit adjustment amount, and a map of the step positions d[1] to d[14] arranged in a predetermined space corresponds to the adjustment map. In other words, for example, when a user performs once the unit operation of instructing to increase the in-focus distance of the target input image 300, the in-focus distance of the target input image 300 is changed by the digital focus from the subject distance at the step position d[i] to the subject distance at the step position d[i+1]. When the user performs twice the unit operation of instructing to increase the in-focus distance of the target input image 300, the in-focus distance of the target input image 300 is changed by the digital focus from the subject distance at the step position d[i] to the subject distance at the step position d[i+2]. In this way, the unit adjustment amount of the in-focus state is set finely in the distance ranges (341 and 343) in which the subject presence degree is high, while the unit adjustment amount of the in-focus state is set roughly in the distance range (342) in which the subject presence degree is low (see FIG. 10).

The in-focus distance and depth of field designation portion 54 sets a designated in-focus distance and a designated depth of field using the adjustment map in accordance with an adjustment instruction operation issued by a user. The adjustment instruction operation is an operation to instruct adjustment (i.e., change) of the in-focus state of the target input image, and is a predetermined operation to the operating portion 18 or a touch panel operation to the display portion 16, for example.

The designated in-focus distance is an in-focus distance after the in-focus state adjustment by the digital focus. In other words, the designated in-focus distance is a target value of the in-focus distance of the target output image obtained by the digital focus. The designated depth of field is a depth of field after the in-focus state adjustment by the digital focus. In other words, the designated depth of field is a target value of the depth of field of the target output image obtained by the digital focus.

The designated depth of field is information designating the maximum distance and the minimum distance in the depth of field. The maximum distance and the minimum distance in the designated depth of field correspond to the maximum distance and the minimum distance in the depth of field of the target output image, respectively. Because a difference between the maximum distance and the minimum distance in the depth of field is a depth value of the depth of field, the designated depth of field specifies the depth value of the depth of field of the target output image. Note that the designated depth of field may be information specifying only a depth value of the depth of field. In this case, the depth of field having a depth value specified by the designated depth of field with the center at the designated in-focus distance is the depth of field after the in-focus state adjustment.

The designated in-focus distance and the designated depth of field at time point when the adjustment instruction operation is never performed are respectively referred to as an initial value of the designated in-focus distance and an initial value of the designated depth of field. It is preferable that the initial value of the designated in-focus distance and the initial value of the designated depth of field are respectively the same as the in-focus distance and the depth of field before the in-focus state adjustment, namely the in-focus distance and the depth of field of the target input image 300. The in-focus distance of the target input image 300 can be determined from a state of each lens of the optical system 35 when the target input image 300 is taken (in particular, a position of the focus lens 31). The depth value of the depth of field of the target input image 300 can be obtained from an aperture stop value and a focal length when the target input image 300 is taken. When the in-focus distance and the depth value of the depth of field are known, the maximum distance and the minimum distance in the depth of field can be determined.

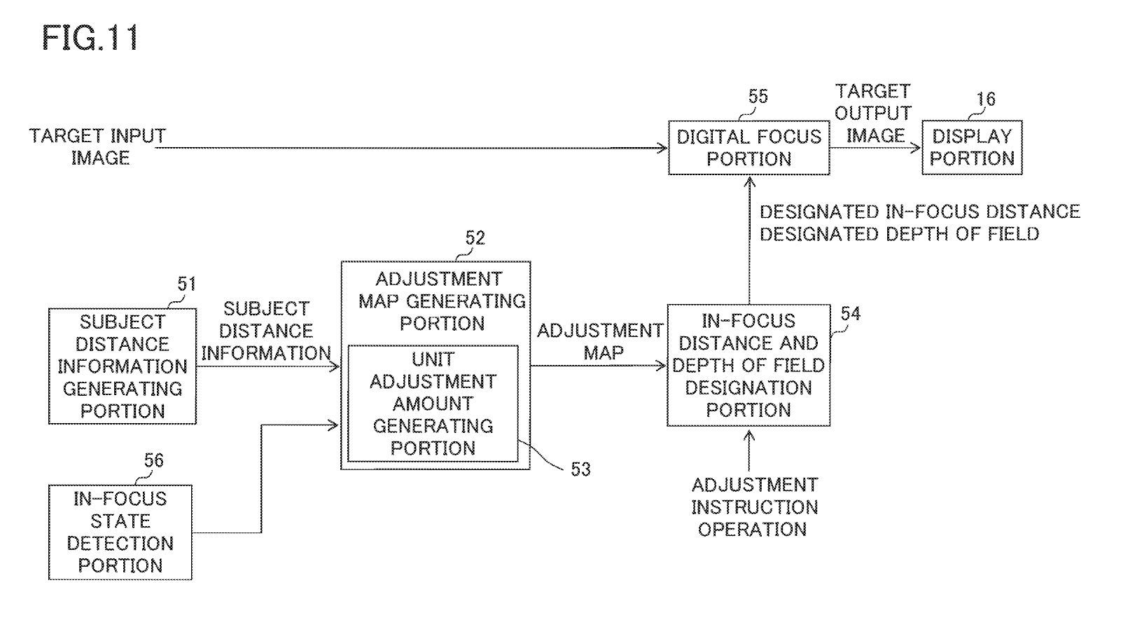

In addition, although not considered particularly in the above description, it is preferable to dispose an in-focus state detection portion 56 for detecting the in-focus distance and the depth of field of the target input image 300 in the imaging apparatus 1 as illustrated in FIG. 11, and to generate the adjustment map so that a subject distance of any one of step positions in the adjustment map agrees with the in-focus distance of the target input image 300 (i.e., the initial value of the designated in-focus distance). Thus, the initial value of the designated in-focus distance can agree with a subject distance of any one of step positions (e.g., d[4]) in the adjustment map. Further, it is possible to generate the adjustment map so that subject distances of any two step positions in the adjustment map agree with the maximum distance and the minimum distance of the depth of field in the target input image 300. Thus, the maximum distance and the minimum distance of the depth of field determined by the initial value of the designated depth of field can agree with subject distances of any two step positions (e.g., d[5] and d[3]) in the adjustment map.

Note that it is possible that the in-focus state detection portion 56 also detects an in-focus position of the target input image 300. The in-focus position of the target input image 300 means a position, on the target input image 300, in an in-focus area included in the whole image area of the target input image 300. The in-focus area means an image area in which image data of a focused subject exists. The in-focus area and the in-focus position of the target input image 300 can be detected by using the spatial frequency components or the like of the target input image 300.

The digital focus portion 55 performs the digital focus on the target input image so that the in-focus distance of the target output image agrees with the designated in-focus distance and that the depth of field of the target output image agrees with the designated depth of field. The obtained target output image is displayed on the display portion 16.

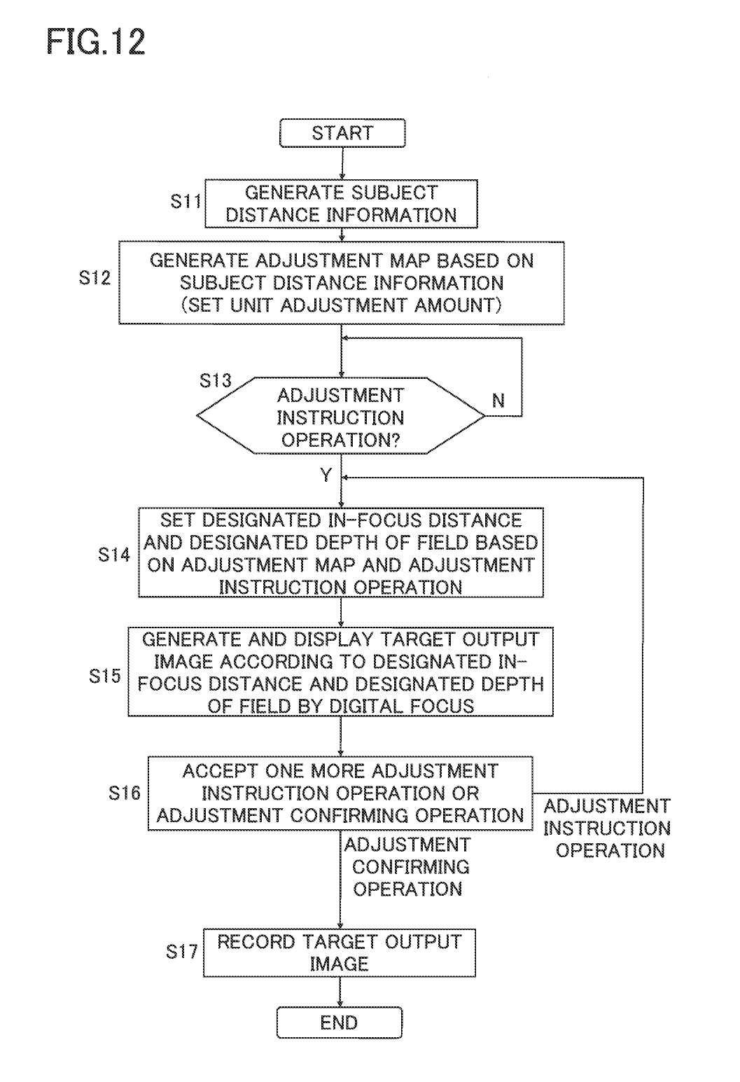

With reference to FIG. 12, a flow of operation for generating the target output image from the target input image 300 is described. FIG. 12 is a flowchart illustrating the flow of the operation. First, the subject distance information is generated in Step S11. In the next Step S12, the adjustment map is generated based on the subject distance information. In other words, the step positions d[1] to d[14] including information of the unit adjustment amount is generated. After that, in Step S13, the adjustment instruction operation by a user is accepted. If there is the adjustment instruction operation, in Step S14, the designated in-focus distance and the designated depth of field are set based on the adjustment map and content of the adjustment instruction operation. The adjustment instruction operation consists of one or more unit operations.

If the designated in-focus distance at the present time point is the subject distance at the step position d[i], and if the unit operation to instruct an increase of the in-focus distance is performed j times by a user, the designated in-focus distance is changed to the subject distance at the step position d[i+j]. If the designated in-focus distance at the present time point is the subject distance at the step position d[i], and if the unit operation to instruct a decrease of the in-focus distance is performed j times by a user, the designated in-focus distance is changed to the subject distance at the step position d[i−j](j denotes an integer). However, an upper limit of the designated in-focus distance is a subject distance at the step position d[14] that agrees with the distance d_{MAX}, and a lower limit of the designated in-focus distance is a subject distance at the step position d[1] that agrees with the distance d_{MIN}. Therefore, the adjustment instruction operation to instruct an increase of the designated in-focus distance to be larger than the subject distance at the step position d[14] and the adjustment instruction operation to instruct a decrease of the designated in-focus distance to be smaller than the subject distance at the step position d[1] are neglected. When the adjustment instruction operation is neglected, a warning display indicating the neglect may be performed.

If the maximum distance and the minimum distance in the designated depth of field are the subject distances of step positions d[i_{A}] and d[i_{B}], respectively, and if the unit operation to instruct an increase of the depth of field is performed j times by a user, the maximum distance and the minimum distance in the designated depth of field are changed to the subject distances of step positions d[i_{A}+j] _{and} d[i_{B}−j], respectively. If the maximum distance and the minimum distance in the designated depth of field are the subject distances of step positions d[i_{A}] and d[i_{B}], respectively, and if the unit operation to instruct a decrease of the depth of field is performed j times by a user, the maximum distance and the minimum distance in the designated depth of field are changed to the subject distances of step positions d[i_{A}−j] and d[i_{B}+j]. Symbols i_{A} and i_{B} denote integers that satisfy “i_{A}>i_{B}>0”.

Alternatively, if the maximum distance and the minimum distance in the designated depth of field are subject distances at the step positions d[i_{A}] and d[i_{B}], respectively, and if the unit operation to instruct an increase of the depth of field is performed j times, the minimum distance in the designated depth of field may be maintained to be the subject distance at the step position d[i_{B}] while the maximum distance in the designated depth of field may be changed to the subject distance at the step position d[i_{A}+j] or, alternatively, the maximum distance in the designated depth of field may be maintained to be the subject distance at the step position d[i_{A}] while the minimum distance in the designated depth of field may be changed to the subject distance in the step position d[i_{B}−j]. Similarly, if the maximum distance and the minimum distance in the designated depth of field are the subject distances at the step positions d[i_{A}] and d[i_{B}], respectively, and if the unit operation to instruct a decrease of the depth of field j times, the minimum distance in the designated depth of field may be maintained to be the subject distance at the step position d[i_{B}] while the maximum distance in the designated depth of field may be changed to the subject distance at the step position d[i_{A}−j] or, alternatively, the maximum distance in the designated depth of field may be maintained to be the subject distance at the step position d[i_{A}] while the minimum distance in the designated depth of field may be changed to the subject distance at the step position d[i_{B}+j].

However, an upper limit of the maximum distance in the designated depth of field is a subject distance at the step position d[14] that agrees with the distance d_{MAX}, and a lower limit of the minimum distance in the designated depth of field is a subject distance at the step position d[1] that agrees with the distance d_{MIN}. Therefore, the adjustment instruction operation to instruct an increase of the maximum distance in the designated depth of field to be larger than the subject distance at the step position d[14] and the adjustment instruction operation to instruct a decrease of the minimum distance in the designated depth of field to be smaller than the subject distance at the step position d[1] are neglected. Further, the adjustment instruction operation to instruct a decrease of the designated depth value of the depth of field to be zero or smaller is also neglected. For instance, if i_{A}=4 and i_{B}=3 are satisfied, the adjustment instruction operation to instruct a decrease of the depth of field is neglected. When the adjustment instruction operation is neglected, a warning display indicating the neglect may be performed.

After Step S14 illustrated in FIG. 12, Step S15 is performed. In Step S15, the target output image having the in-focus distance and the depth of field according to the latest designated in-focus distance and designated depth of field is generated by the digital focus, and the generated target output image is displayed.

After that, in Step S16, the main control portion 20 illustrated in FIG. 1 accepts user's one more adjustment instruction operation or adjustment confirming operation. When the one more adjustment instruction operation is performed, the process flow goes back to Step S14, and the process of Step S14 and thereafter is performed repeatedly. In other words, the designated in-focus distance and the designated depth of field are reset based on the adjustment map and content of the one more adjustment instruction operation, and the target output image in accordance with the reset designated in-focus distance and designated depth of field is regenerated by the digital focus and is displayed.

If the adjustment confirming operation is performed in Step S16, the image data of the currently displayed target output image is recorded in the recording medium 19 (Step S17). In this case, additional data may be recorded in the recording medium 19 in association with the image data of the target output image. The additional data may contain a latest designated in-focus distance and a latest designated depth of field.

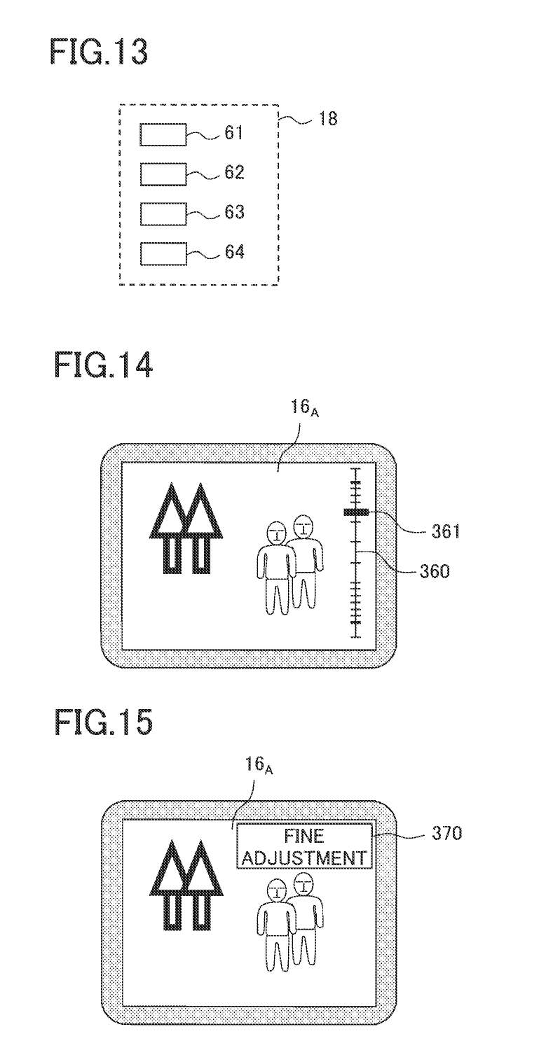

As illustrated in FIG. 13, it is supposed that the operating portion 18 is equipped with four buttons 61 to 64, and more specific operational example is described. It is supposed that an operation of pressing the button 61 one time is the one unit operation to instruct an increase of the in-focus distance, and an operation of pressing the button 62 one time is the one unit operation to instruct a decrease of the in-focus distance. Note that if a touch panel is used for the unit operation, the buttons 61 to 64 may be buttons displayed on a display screen.

Now, it is supposed that the in-focus distance of the target input image 300 agrees with the subject distance at the step position d[4]. In this situation, if the button 61 is pressed once, twice, three times, four times, five times, six times or seven times, the designated in-focus distance is changed to the subject distance of the step position d[5], d[6], d[7], d[8], d[9], d[10] or d[11], respectively. In addition, although different from the situation illustrated in FIG. 5A, in the situation where the in-focus distance of the target input image 300 is agreed with the subject distance at the step position d[11], if the button 62 is pressed once, twice, three times, four times, five times, six times or seven times, the designated in-focus distance is changed to the subject distance at the step positions d[10], d[9], d[8], d[7], d[6], d[5] or d[4], respectively. In this way, when the designated in-focus distance is changed in presence ranges 341 and 343, the designated in-focus distance is changed in detail by the unit operation. On the other hand, when the designated in-focus distance is changed in the absence range 342, the designated in-focus distance is changed roughly by the unit operation.

In addition, it is supposed that an operation of pressing the button 63 one time is the one unit operation to instruct an increase of the depth of field, and that an operation of pressing the button 64 one time is the one unit operation to instruct a decrease of the depth of field. The user can designate by another operation whether only the maximum distance in the depth of field should be changed, or only the minimum distance in the depth of field should be changed, or both of them should be changed by an operation of the button 63. Similarly, the user can designate by another operation whether only the maximum distance in the depth of field should be changed, or only the minimum distance in the depth of field should be changed, or both of them should be changed by an operation of the button 64. Here, for convenience sake of description, an operational example is described, in which only the maximum distance in the depth of field is changed by the operation of the button 63, and only the minimum distance in the depth of field is changed by the operation of the button 64.

It is supposed that the maximum distance in the depth of field of the target input image 300 agrees with the subject distance at the step position d[5]. In this situation, when the button 63 is pressed once, twice, three times, four times, five times or six times, the maximum distance in the designated depth of field is changed to the subject distance of the step position d[6], d[7], d[8], d[9], d[10] or d[11], respectively. In addition, although different from the situation illustrated in FIG. 5A, in the situation where the maximum distance and the minimum distance in the depth of field of the target input image 300 agree with the subject distances at the step positions d[12] and d[5], if the button 64 is pressed once, twice, three times, four times, five times or six times, the minimum distance in the designated depth of field is changed to the subject distance at the step position d[6], d[7], d[8], d[9], d[10] or d[11], respectively. In this way, when the maximum distance or the minimum distance in the designated depth of field is changed in the presence ranges 341 and 343, the maximum distance or the minimum distance is changed in detail by the unit operation. On the other hand, when the maximum distance or the minimum distance in the designated depth of field is changed in the absence range 342, the maximum distance or the minimum distance is changed roughly by the unit operation.

Note that an operation of pressing the button 61 continuously (a so-called long press operation) may be regarded as a plurality of times of the unit operation. The same is true for the buttons 62 to 64.

When trying to adjust the in-focus state by the digital focus, the user usually pays attention to any one subject for adjusting the in-focus state. For instance, the in-focus distance is adjusted in detail so that a specific person in the subject 301 is best focused, or the in-focus distance is adjusted in detail so that a specific tree in the subject 302 is best focused (see FIG. 4). In addition, for example, the depth of field is decreased slightly so that only the specific person in the subject 301 is focused, or the depth of field is increased slightly so that a person positioned close to the specific person is also focused. Therefore, in distance ranges (341 and 343) having a high subject presence degree, it is necessary to set the unit adjustment amount of the in-focus state in detail. On the other hand, even if the unit adjustment amount of the in-focus state is set in detail in the distance range (342) having a low subject presence degree, it is less use. It is rather preferable to set the same roughly so that the designated in-focus distance can be quickly changed from a vicinity of the subject distance d₃₀₁ to the vicinity of the subject distance d₃₀₂ or from a vicinity of the subject distance d₃₀₂ to the vicinity of the subject distance d₃₀₁. Similarly, it is possible to change the maximum distance or the minimum distance in the designated depth of field quickly from the vicinity of the subject distance d₃₀₁ to the vicinity of the subject distance d₃₀₂ or from the vicinity of the subject distance d₃₀₂ to the vicinity of the subject distance d₃₀₁.

Based on this consideration, in this embodiment, the unit adjustment amount is set in detail in the distance ranges (341 and 343) having a high subject (i.e., object) presence degree so that fine adjustment of the in-focus state can be performed. In the distance range (342) having a low subject presence degree, the unit adjustment amount is set roughly so that rough adjustment of the in-focus state can be performed. Thus, adjustment in accordance with user's intention is realized so that user's operation for the in-focus state adjustment can be simplified.

During execution of the process of Steps S11 to S17 illustrated in FIG. 12, as illustrated in FIG. 14, it is possible to display the adjustment map together with the target output image. In the situation where the adjustment instruction operation is not performed yet, the target output image is the same as the target input image. FIG. 14 illustrates a display screen 16_{A} of the display portion 16 on which the target output image is displayed. In FIG. 14, the dot-filled area indicates a casing of the display portion 16 (the same is true in FIG. 15 that will be referred to later). In the example illustrated in FIG. 14, the adjustment map is displayed as a bar icon 360 on the display screen 16_{A}. The bar icon 360 is provided with lines corresponding to the step positions, and an icon 361 indicating the designated in-focus distance and the designated depth of field at the present time point is displayed on the bar icon 360. By viewing the bar icon 360 and the icon 361, the user can directly recognize the designated in-focus distance and the designated depth of field at the present time point and can recognize whether an adjustment mode at the present time point is a fine adjustment mode or a rough adjustment mode.

The fine adjustment mode means an adjustment mode in the state where the designated in-focus distance belongs to the subject presence distance range, and the rough adjustment mode means an adjustment mode in the state where the designated in-focus distance belongs to the subject absence distance range (see FIG. 7). Alternatively, the fine adjustment mode means an adjustment mode in the state where the maximum distance and the minimum distance in the designated depth of field belong to the subject presence distance range, and the rough adjustment mode means an adjustment mode in the state where at least one of the maximum distance and the minimum distance in the designated depth of field belongs to the subject absence distance range.

During execution of the process of Steps S11 to S17 illustrated in FIG. 12, an index 370 indicating which one of the fine adjustment mode and the rough adjustment mode is the adjustment mode at the present time point may be displayed together with the target output image as illustrated in FIG. 15. By this too, as a matter of course, the user can recognize whether the adjustment mode at the present time point is the fine adjustment mode or the rough adjustment mode. It is preferable to display the index 370 illustrated in FIG. 15 and the bar icon 360 and the icon 361 illustrated in FIG. 14 at the same time.

### Second Embodiment

A second embodiment of the present invention is described. The second embodiment is an embodiment based on the first embodiment, and the description in the first embodiment is applied also to second embodiment unless otherwise noted, as long as no contradiction arises.

In the second embodiment, the structure illustrated in FIG. 11 is used, setting of the unit adjustment amount and generation of the adjustment map are performed based on the in-focus distance of the target input image 300 detected by the in-focus state detection portion 56 and the subject distance information from the subject distance information generating portion 51.

Similarly to the first embodiment, it is supposed that the target input image is the image 300 illustrated in FIG. 5A. In this case, the adjustment map generating portion 52 generates the adjustment map for the depth of field based on the minimum distance d_{MIN} and the maximum distance d_{MAX} extracted from the subject distance information and the in-focus distance d_{O} of the target input image 300. Here, it is supposed that the minimum distance d_{MIN} and the maximum distance d_{MAX} are the same as the subject distances at the step positions d[1] and d[14], respectively, similarly to the first embodiment, and that the adjustment map generating portion 52 generates the adjustment map consisting of the step positions d[1] to d[14].

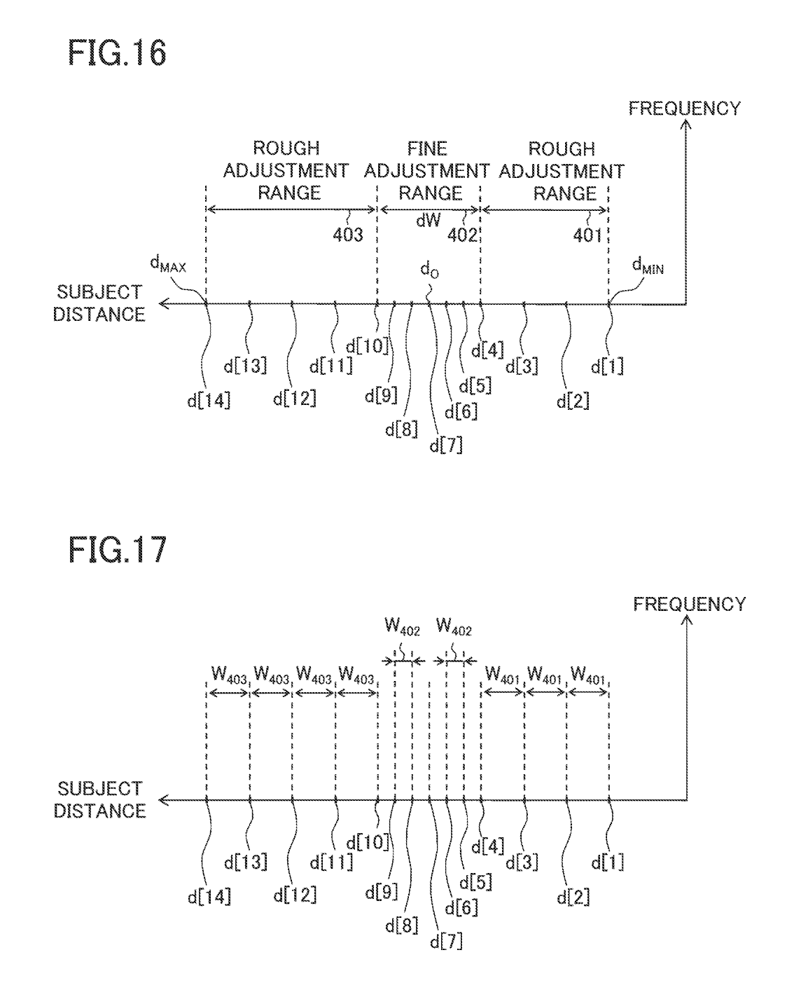

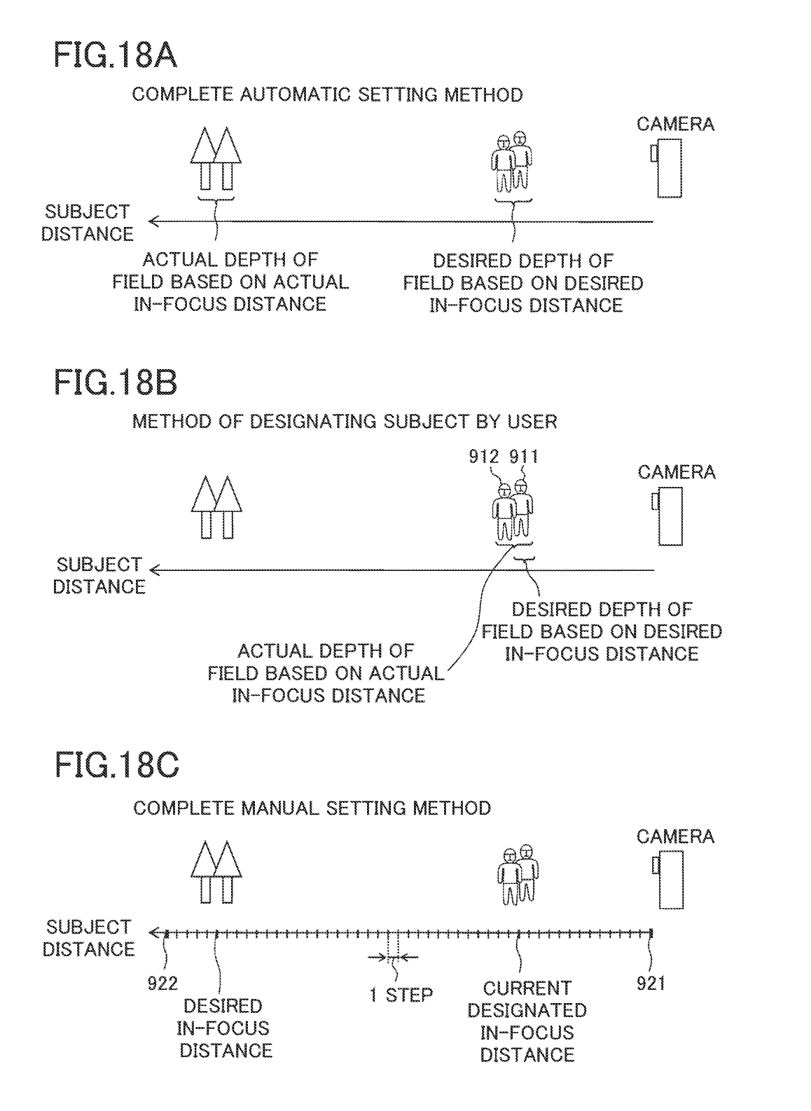

As illustrated in FIG. 16, the adjustment map generating portion 52 sets a distance range having the center at the in-focus distance d_{O} and having a predetermined distance width dW as the fine adjustment range, and sets a distance range that does not belong to the fine adjustment range as the rough adjustment range (dW>0). Then, the fine adjustment range is split into a plurality of unit distance ranges. The unit distance range means a range from the step position d[i] to the step position d[i+1] as described above in the first embodiment. FIG. 16 illustrates an example of the fine adjustment range and the rough adjustment range to be set. In this example, the in-focus distance d_{O} is the same as the subject distance at the step position d[7], a distance range from the step position d[4] to the step position d[10] is set as a fine adjustment range 402, a distance range from the step position d[1] to the step position d[4] is set as a rough adjustment range 401, and a distance range from the step position d[10] to the step position d[14] is set as a rough adjustment range 403. Note that the step positions d[4] and d[10] are supposed to belong not to the rough adjustment ranges 401 and 403 but to the fine adjustment range 402. In addition, it is supposed that the step position d[1] also belongs to the rough adjustment range 401, and that the step position d[14] also belongs to the rough adjustment range 403.

Note that if an inequality “d_{O}−d_{MIN}<dW/2” is satisfied because of any reason such as the reason that the in-focus distance d_{O} is close to the minimum distance d_{MIN}, the fine adjustment range that is once set as the distance range having the center at the in-focus distance d_{O} and having the distance width dW is reduced and corrected so as not to include distances smaller than the minimum distance d_{MIN}. Similarly, if an inequality “d_{MAX}−d_{O}<dW/2” is satisfied because of any reason such as the reason that the in-focus distance d_{O} is close to the maximum distance d_{MAX}, the fine adjustment range that is once set as the distance range having the center at the in-focus distance d_{O} and having the distance width dW is reduced and corrected so as not to include distances larger than the maximum distance d_{MAX}. In the example illustrated in FIG. 16, the reduction and correction is not performed.

The adjustment map generating portion 52 sets the width of each unit distance range belonging to the fine adjustment range 402 smaller than the width of each unit distance range belonging to the rough adjustment ranges 401 and 403.

The unit distance ranges belonging to the rough adjustment range 401 are unit distance ranges (d[1], d[2]), (d[2], d[3]) and (d[3], d[4]), the unit distance ranges belonging to the fine adjustment range 402 are unit distance ranges (d[4], d[5]), (d[5], d[6]), (d[6], d[7]), (d[7], d[8]), (d[8], d[9]) and (d[9], d[10]), and the unit distance range belonging to the rough adjustment range 403 are unit distance ranges (d[10], d[11]), (d[11], d[12]), (d[12], d[13]) and (d[13], d[14]).

As illustrated in FIG. 17, the width of each unit distance range belonging to the rough adjustment range 401 can be a constant width W₄₀₁, the width of each unit distance range belonging to the fine adjustment range 402 can be a constant width W₄₀₂, and the width of each unit distance range belonging to the rough adjustment range 403 can be a constant width W₄₀₃. Here, “0<W₄₀₂<W₄₀₁” and “0<W₄₀₂<W₄₀₃” are satisfied. The width W₄₀₁ and the width W₄₀₃ may be the same or different from each other. Note that the width of the unit distance range may be different among a plurality of unit distance ranges belonging to the rough adjustment range 401, the width of the unit distance range may be different among a plurality of unit distance ranges belonging to the fine adjustment range 402, and the width of the unit distance range may be different among a plurality of unit distance ranges belonging to the rough adjustment range 403. However, in this case too, as described above, the width of each unit distance range belonging to the fine adjustment range 402 is set to be smaller than the width of each unit distance range belonging to the rough adjustment ranges 401 and 403.

The width of each unit distance range can work as the unit adjustment amount. Then, the process of setting the step positions d[1] to d[14] satisfying the above-mentioned relationship corresponds to the setting process of the unit adjustment amount, and a map in which the step positions d[1] to d[14] are arranged in a predetermined space corresponds to the adjustment map. However, the step positions d[1] to d[14] described in this embodiment is used only for adjustment of the depth of field. In other words, the map in which the step positions d[1] to d[14] are arranged as described in this embodiment is the adjustment map for the depth of field. The adjustment map for the in-focus distance is set based on the distance distribution 320 as described above in the first embodiment (see FIGS. 8, 9 and the like).

An operation after generating the adjustment map is the same as that described above in the first embodiment, and the operation flow of generating the target output image from the target input image 300 is the same as that in the first embodiment (see FIG. 12).

In other words, in Step S12 of FIG. 12, the adjustment map for the in-focus distance is generated based on the distance distribution 320 and the adjustment map for the depth of field is generated based on the minimum distance d_{MIN}, the maximum distance d_{MAX} and the in-focus distance d_{O}. After that, the adjustment instruction operation by the user is accepted in Step S13. If the adjustment instruction operation for the in-focus distance is accepted, the designated in-focus distance is set based on the adjustment map for the in-focus distance and content of the adjustment instruction operation in Step S14. If the adjustment instruction operation for the depth of field is accepted, the designated depth of field is set based on the adjustment map for the depth of field and content of the adjustment instruction operation in Step S14. The setting method of the designated in-focus distance is the same as that in the first embodiment.

The setting method of the designated depth of field is also the same as that in the first embodiment, but the step positions illustrated in FIGS. 16 and 17 are used as step positions of the subject distances to be the maximum distance and the minimum distance of the designated depth of field. Therefore, in the fine adjustment range 402 that is a distance range near the in-focus distance d_{O}, the depth of field can be adjusted in detail because the unit adjustment amount is set in detail. On the other hand, in the rough adjustment ranges 401 and 403 that are distance ranges apart from the in-focus distance d_{O}, the depth of field is changed roughly because the unit adjustment amount is set roughly.

When trying to adjust the in-focus state by the digital focus, the user usually pays attention to any one of subjects for adjusting the in-focus state. For instance, the depth of field is decreased by a slight amount so that only the specific person in the subject 301 is focused, or the depth of field is increased by a slight amount so that a person positioned close to the specific person is also focused. On the other hand, such a specific person is usually positioned in the vicinity of the in-focus distance d_{O} when the target input image 300 is taken. Therefore, in the distance range (402) near the in-focus distance d_{O}, it is preferable to set the unit adjustment amount of the depth of field in detail so as to satisfy the user's intention. On the other hand, even if the unit adjustment amount of the depth of field is set in detail in the distance ranges (401 and 403) that are far from the in-focus distance d_{O}, it is less use. It is rather preferable to set the same roughly so that the adjustment operation for setting a subject in a long distant to be in the depth of field can be performed quickly.

Based on this consideration, in this embodiment, the unit adjustment amount for the depth of field is set in detail, in the distance range (402) close to the in-focus distance d_{O}, so that fine adjustment of the depth of field can be performed. In the distance ranges (401 and 403) that are far from the in-focus distance d_{O}, the unit adjustment amount for the depth of field is set roughly so that the depth of field is roughly adjusted. Thus, adjustment in accordance with user's intention is realized, and user's operation for the in-focus state adjustment can be simplified.

Note that the display illustrated in FIG. 14 or 15 can be performed in the second embodiment, too. In other words, during execution of the process of Steps S11 to S17 of FIG. 12, the adjustment map for the depth of field may be displayed together with the target output image. The display method of the adjustment map is the same as that described above in the first embodiment. Similarly, during execution of the process of Steps S11 to S17 of FIG. 12, an index indicating which one of the fine adjustment mode and the rough adjustment mode is the current adjustment mode for the depth of field may be displayed together with the target output image. The fine adjustment mode for the depth of field means an adjustment mode in the state where the maximum distance and the minimum distance in the designated depth of field belong to the fine adjustment range 402, and the rough adjustment mode for the depth of field means an adjustment mode in the state where at least one of the maximum distance and the minimum distance in the designated depth of field belongs to the rough adjustment range 401 or 403.

In addition, the in-focus distance d_{O} and the subject distance information are used for generating the adjustment map for the depth of field in this embodiment, but the fine adjustment range and the rough adjustment range are determined depending mainly on the in-focus distance d_{O}, and the subject distance information is merely used for setting the upper and lower limits of the fine adjustment range or the upper and lower limits of the rough adjustment range. Therefore, if the step positions d[1] and d[14] are determined in advance, it is possible to generate the adjustment map for the depth of field based on only the in-focus distance d_{O}.

### Third Embodiment

A third embodiment of the present invention is described. In the third embodiment, an example of a method of the digital focus performed by the digital focus portion 55 is described.

As a method of changing the in-focus distance and the depth of field of the target input image, the digital focus portion 55 can use any method such as a known method. For instance, the above-mentioned light field method can be used. Using the light field method, a target output image having any in-focus distance and depth of field can be generated from the target input image based on the output signal of the image sensor 33. In this case, a known method based on the light field method (e.g., the method described in WO/06/039486 Pamphlet or JP-A-2009-224982) can be used. As described above, in the light field method, by using an imaging lens having an aperture stop and a micro lens array, the image signal (image data) obtained from the image sensor contains information of the light propagation direction in addition to light intensity distribution on the light receiving surface of the image sensor. The imaging apparatus adopting the light field method performs image processing based on the image signal from the image sensor and can reconstruct an image having any in-focus distance and depth of field. In other words, if the light field method is used, a target output image in which any subject is focused can be constructed freely after taking the target input image.

Therefore, although not illustrated in FIG. 2, an optical member necessary for realizing the light field method is disposed in the imaging portion 11 when the light field method is used. This optical member includes a micro lens array and the like as described above in the first embodiment, and the incident light from the subject enters the light receiving surface (i.e., the imaging surface) of the image sensor 33 via the micro lens array and the like. The micro lens array consists of a plurality of micro lenses, and one micro lens is assigned to the one or more light receiving pixels on the image sensor 33. Thus, the output signal of the image sensor 33 contains information of the incident light propagation direction to the image sensor 33 in addition to the light intensity distribution on the light receiving surface of the image sensor 33. By using the image data of the target input image containing this information, the digital focus portion 55 can freely change the in-focus distance and the depth of field of the target input image.

The digital focus portion 55 can also perform the digital focus by a method that is not based on the light field method. For instance, the digital focus may include an image restoring process to eliminate deterioration due to a blur in the target input image. As a method of the image restoring process, a known method can be used. When the image restoring process is performed, it is possible to use not only the target input image but also image data of one or more frame images taken at timing close to the target input image. The target input image after the image restoring process is referred to as a whole in-focus image. In the whole in-focus image, the whole image area is the in-focus area.

After the whole in-focus image is generated, the digital focus portion 55 can generate the target output image by performing a filtering process on the whole in-focus image using the designated in-focus distance, the designated depth of field and the subject distance information. In other words, any one pixel in the whole in-focus image is set as a noted pixel so that the subject distance of the noted pixel is extracted from the subject distance information, and a distance difference between the subject distance of the noted pixel and the designated in-focus distance is determined. Then, the filtering process is performed on a micro image area having the center at the noted pixel so that the image in the micro image area is blurred more largely as the distance difference determined for the noted pixel is larger. However, if the distance difference is smaller than or equal to a half of the designated depth value of the depth of field, execution of the filtering process can be stopped. The above-mentioned process is performed on pixels in the whole in-focus image sequentially as the noted pixel, and a result image obtained after the whole filtering process is finished can be used as the target output image.

<<Variations>>

The embodiments of the present invention can be modified variously as necessary within the scope of the technical concept described the claims. The embodiments are merely examples of embodying the present invention, and meanings of terms in the present invention and elements thereof should not be limited to those described in the embodiments. The specific values shown in the above-mentioned description are merely examples and can be changed variously as a matter of course. As annotations that can be applied to the above-mentioned embodiments, Note 1 to Note 3 are described below. The contents of the notes can be combined freely as long as no contradiction arises.

[Note 1]

The setting method of the unit adjustment amount according to the present invention is used for both the in-focus distance and the depth of field in the above-mentioned embodiments, but the setting method of the unit adjustment amount according to the present invention may be used for only one of the in-focus distance and the depth of field.

[Note 2]

The imaging apparatus 1 accepts the adjustment instruction operation and performs the digital focus in the above-mentioned embodiments, but it is possible that electronic equipment (not shown) other than the imaging apparatus 1 accepts the adjustment instruction operation and performs the digital focus. Here, the electronic equipment is, for example, a personal computer or an information terminal such as a personal digital assistant (PDA). Note that the imaging apparatus 1 is a type of the electronic equipment. The electronic equipment is equipped with the portions illustrated in FIG. 3 or the portions illustrated in FIG. 11, for example. The image data of the target input image and information necessary for generating the adjustment map are supplied to the electronic equipment. The adjustment instruction operation is given to the electronic equipment. Thus, the target output image can be generated, displayed and recorded on the electronic equipment.

[Note 3]

The imaging apparatus 1 illustrated in FIG. 1 or the above-mentioned electronic equipment can be constituted of hardware, or a combination of hardware and software. When the imaging apparatus 1 or the above-mentioned electronic equipment is constituted using software, the block diagram of each portion realized by the software expresses a functional block diagram of the portion. The function realized using the software may be described as a program, and the program may be executed by a program executing device (e.g., a computer) so that the function is realized.

What is claimed is:

1. An electronic equipment comprising:
a digital focus portion that adjusts an in-focus state of a target image by image processing; and
a unit adjustment amount setting portion that sets a unit adjustment amount in adjustment of the in-focus state based on distance information of the target image.

2. The electronic equipment according to claim 1, wherein
the distance information is information indicating a distance between an object at each position on the target image and an apparatus that has taken the target image, and
the unit adjustment amount setting portion sets the unit adjustment amount in accordance with distribution of the distance.

3. The electronic equipment according to claim 2, wherein the unit adjustment amount setting portion sets the unit adjustment amount in a distance range with a relatively high frequency in the distribution to be smaller than the unit adjustment amount in a distance range with a relatively low frequency in the distribution.

4. The electronic equipment according to claim 1, wherein the unit adjustment amount includes at least one of a unit adjustment amount for an in-focus distance that is a reference distance in a depth of field of the target image and a unit adjustment amount for the depth of field of the target image.

5. The electronic equipment according to claim 1, wherein the unit adjustment amount indicates an adjustment amount of the in-focus state per unit operation.

6. An electronic equipment comprising:
a digital focus portion that adjusts an in-focus state of a target image including a depth of field of the target image by image processing; and
a unit adjustment amount setting portion that sets a unit adjustment amount in adjustment of the depth of field based on an in-focus distance as a reference distance in the depth of field.

7. The electronic equipment according to claim 6, wherein the unit adjustment amount setting portion sets the unit adjustment amount in a distance range that includes the in-focus distance and is relatively close to the in-focus distance to be smaller than the unit adjustment amount in a distance range that is relatively far from the in-focus distance.

8. The electronic equipment according to claim 6, wherein the unit adjustment amount indicates an adjustment amount of the depth of field per unit operation.
